(19) United States
(12) Patent Application Publication
(10) Pub. No.: US 2020/0195798 A1
(43) Pub. Date: Jun. 18, 2020

(54) IMAGE READING DEVICE, IMAGE FORMING SYSTEM, METHOD OF CONTROLLING IMAGE READING DEVICE, AND PROGRAM

(71) Applicant: Konica Minolta Inc., Tokyo (JP)

(72) Inventor: Tomomi IZAWA, Tokyo (JP)

(21) Appl. No.: 16/713,597

(22) Filed: Dec. 13, 2019

(30) Foreign Application Priority Data
Dec. 14, 2018 (JP) 2018-234194

(51) Int. Cl. H04N 1/00

(52) U.S. Cl. CPC H04N 1/00734; H04N 1/00602; H04N 1/00037; H04N 1/0071

(57) ABSTRACT

An image reading device includes: an image reading part that is disposed opposite paper conveyed along a conveyance path, and reads an image formed on the paper; and a hardware processor that performs an abnormality detection operation of detecting an abnormality in the image reading part, based on a first read image and a second read image that is different from the first read image in paper position at image reading time in a paper width direction orthogonal to a paper conveyance direction.

### CROSS REFERENCE TO RELATED APPLICATIONS

The present invention claims priority under 35 U.S.C. § 119 to Japanese patent Application No. 2018-234194, filed on Dec. 14, 2018, is incorporated herein by reference in its entirety.

### BACKGROUND

### Technological Field

The present invention relates to an image reading device, an image forming system, a method of controlling the image reading device, and a program

### Description of the Related art

An image forming device and an image forming system including the image forming device have been known. This type of image forming system can use not only paper having a certain size but also long paper such as roll paper and form paper (hereinafter referred to as “continuous paper”).

An image forming system including an image reading device that reads an image formed on paper has also been known. The image reading device is disposed downstream of the image forming device in a paper conveyance direction, and reads paper on which an image is formed by the image forming device. Based on the read image, the image reading device performs an inspection of the image, specifically, a calculation for image adjustment and an evaluation of image quality such as stains and reproducibility.

When dirt such as dust or paper powder has adhered to a reading surface of an image reading part, a streak mark (vertical streak) extending in the paper conveyance direction appears on the read image. Against this, for example, JP 2011-171992 A discloses a document reading device that determines whether a vertical streak appearing on a read image is a vertical line as an image or a vertical streak caused by dirt.

The document reading device can automatically convey a document in a sub-scanning direction, and photoelectrically converts light reflected from the document irradiated by a light source into an image signal with a plurality of line sensors disposed in parallel in the sub- scanning direction, and after digital conversion, corrects misalignment in the sub-scanning direction between the plurality of line sensors. When a document is inclined at a preset angle with respect to the plurality of line sensors and automatically conveyed at a preset speed, read data of the same main scanning pixel in the plurality of line sensors are compared in the sub- scanning direction to detect differences between the read data of the plurality of line sensors, and it is determined whether the state of the differences between the read data continues for a predetermined number of lines.

However, in the technique disclosed in JP 2011-171992 A, the paper is conveyed obliquely, so that a speed difference from a proper conveyance speed is made in the paper conveyance direction. In this case, due to excessive or insufficient inter-line correction, characteristic data (a colored image with R, G, and B misaligned) is generated at the edges of the image. This causes a problem that image inspection cannot be performed accurately.

### SUMMARY

The present invention has been made in view of these circumstances, and an object of the present invention is to provide an image reading device, an image forming system, a method of controlling the image reading device, and a program that can detect an abnormality in an image reading part accurately while inspecting an image accurately.

To achieve the abovementioned object, according to an aspect of the present invention, an image reading device reflecting one aspect of the present invention comprises: an image reading part that is disposed opposite paper conveyed along a conveyance path, and reads an image formed on the paper; and a hardware processor that performs an abnormality detection operation of detecting an abnormality in the image reading part, based on a first read image and a second read image that is different from the first read image in paper position at image reading time in a paper width direction orthogonal to a paper conveyance direction.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an explanatory diagram schematically showing a configuration of an image forming system according to the present embodiment;

FIG. 2 is an explanatory diagram schematically showing a configuration of an image forming device;

FIG. 3 is an explanatory diagram explaining a steering mechanism mounted in an image reading device;

FIG. 4 is an explanatory diagram showing retracted positions of conveying rollers;

FIG. 5A and FIG. 5B are explanatory diagrams showing the concept of dirt detection;

FIG. 6A and FIG. 6B are explanatory diagrams showing the concept of dirt detection;

FIG. 7 is a flowchart showing an operation of the image reading device; and

FIG. 8 is a flowchart showing details of a dirt detection operation.

### DETAILED DESCRIPTION OF EMBODIMENTS

Hereinafter, one or more embodiments of the present invention will be described with reference to the drawings. However, the scope of the invention is not limited to the disclosed embodiments.

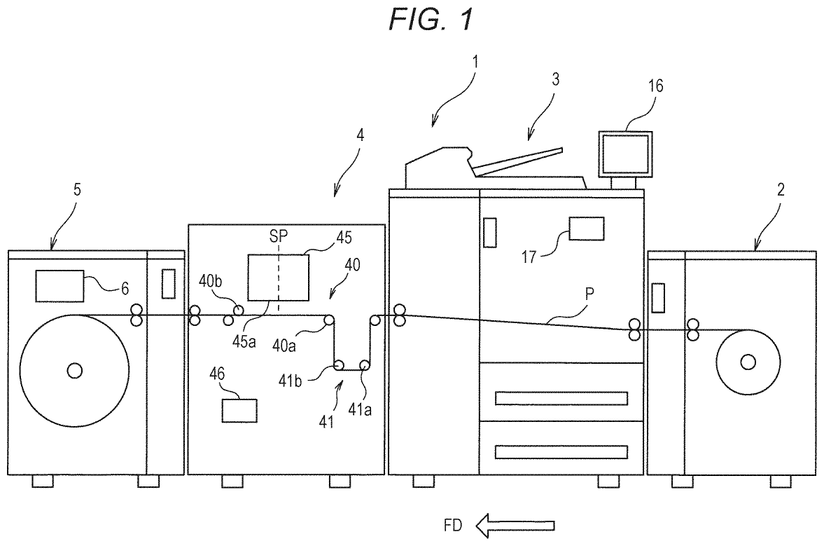

FIG. 1 is an explanatory diagram schematically showing a configuration of an image forming system 1 according to the present embodiment. The image forming system 1 is mainly composed of a paper feed device 2, an image forming device 3, an image reading device 4, a winding device 5, and a system controller 6. The paper feed device 2, the image forming device 3, the image reading device 4, and the winding device 5 are disposed in a conveyance direction FD of continuous paper P (hereinafter referred to as a “paper conveyance direction”) in the order of the paper feed device 2, the image forming device 3, the image reading device 4, and the winding device 5. Other than these devices, the image forming system 1 may additionally include a paper processing device that performs predetermined processing on the continuous paper P on which an image is formed. In the following description, the terms “upstream” and “downstream” are used with reference to the paper conveyance direction FD unless otherwise specified.

The paper feed device 2 stores the continuous paper P, and feeds the continuous paper P to the downstream device in accordance with an instruction from the system controller 6. Here, the continuous paper P is, for example, roll paper. A wide range of long continuous paper such as form paper can be used. For the continuous paper P, material other than paper may be used. A wide range of material such as that made of synthetic resin may be used. The paper feed device 2 is provided with a tension application unit that urges the continuous paper P so that a constant tension is applied to the continuous paper P.

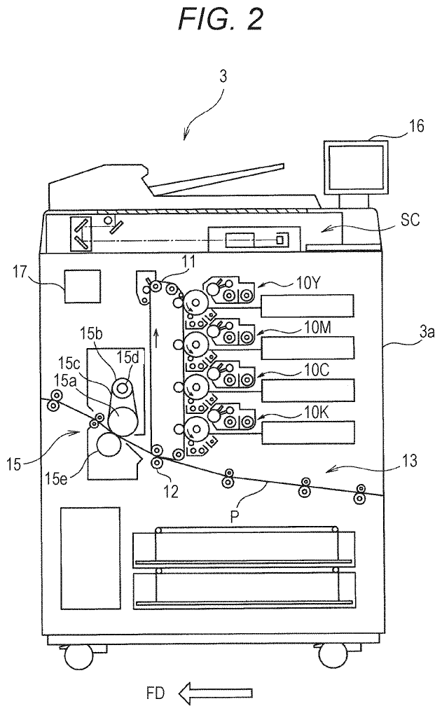

FIG. 2 is an explanatory diagram schematically showing a configuration of the image forming device 3. The image forming device 3 forms an image on the continuous paper P, and outputs the continuous paper P on which the image is formed to the downstream device. In the present embodiment, the image forming device 3 is a device using an electrophotographic process, and is mainly composed of a document reading device SC, image forming units 10Y, 10M, 10C, and 10K, a conveying unit 13, a fixing device 15, an operation display unit 16, and a control unit 17.

The document reading device SC illuminates a document image with an illumination device, and reads the reflected light with a line image sensor, thereby obtaining an image signal. The image signal is subjected to processing such as A/D conversion, shading correction, and compression, and then input to the control unit 17 as image data.

The image forming units 10Y, 10M, 10C, and 10K include the image forming unit 10Y for forming a yellow (Y) image, the image forming unit 10M for forming a magenta (M) image, the image forming unit 10C for forming a cyan (C) image, and the image forming unit 10K for forming a black (K) image.

The image forming unit 10Y includes a photoconductive drum, and a charging unit, an optical writing unit, a developing device, and a drum cleaner that are disposed around the photoconductive drum. In the image forming unit 10Y, an image corresponding to yellow (toner image) is formed on the photoconductive drum, and the image formed on the photoconductive drum is transferred by a primary transfer roller to a predetermined position on an intermediate transfer belt 11 that is an endless belt. The other image forming units 10M, 10C, and 10K also include a photoconductive drum, and a charging unit, an optical writing unit, a developing device, and a drum cleaner that are disposed around the photoconductive drum. Details of them are the same as those of the image forming unit 10Y.

Each color image transferred onto the intermediate transfer belt 11 is transferred to the continuous paper P conveyed by the conveying unit 13, by a secondary transfer roller 12 that forms a transfer nip for the intermediate transfer belt 11. In the present embodiment, the image forming units 10Y, 10M, 10C, and 10K, the intermediate transfer belt 11, and the secondary transfer roller 12 function as an image forming unit for transferring an image to the continuous paper P. Note that the image forming unit may transfer an image directly to the continuous paper P without using the intermediate transfer belt 11.

The conveying unit 13 includes a plurality of conveying rollers. The conveying unit 13 conveys the continuous paper P fed from the paper feed device 2 with the plurality of conveying rollers disposed along a conveyance path, and then discharges the continuous paper P to the image reading device 4.

The fixing device 15 is a device for fixing a transferred image to the continuous paper P. The fixing device 15 includes a pair of fixing members. The fixing members form a fixing nip by being pressed against each other.

One fixing member is disposed on the side facing a surface of the continuous paper P subjected to fixing, that is, a surface to which a toner image has been transferred, and in the present embodiment, above the continuous paper P The one fixing member includes a pressure roller 15a, an upper fixing roller 15b, and an endless fixing belt 15c. The pressure roller 15a and the upper fixing roller 15b are disposed apart from each other by a predetermined distance. The fixing belt 15c is stretched between the rollers 15a and 15b. A heater 15d is provided inside the upper fixing roller 15b.

The other fixing member is disposed on the side facing the back of the surface of the continuous paper P subjected to fixing, and in the present embodiment, below the continuous paper P conveyed. The other fixing member includes a lower fixing roller 15e. The lower fixing roller 15e is disposed to be pressed against the pressure roller 15a with the fixing belt 15c therebetween. Consequently, a fixing nip is formed between the fixing belt 15c and the lower fixing roller 15e.

The operation display unit 16 is an operation unit that accepts input corresponding to a user's operation. For example, the operation display unit 16 includes a display and a touch panel and hard keys such as switches that allow input of information according to information displayed on the display. Information on an operation performed on the operation display unit 16 is input to the control unit 17 or the system controller 6. The operation display unit 16 also functions as a display unit that displays various kinds of information for the user by being controlled by the control unit 17. That is, the user can instruct execution of a print job or perform various settings by operating the operation display unit 16. Also, the user can grasp various kinds of information by visually recognizing information displayed on the operation display unit 16.

The control unit 17 has a function of controlling the image forming device 3. The control unit 17 is communicably connected to the paper feed device 2, the image reading device 4, the winding device 5, and the system controller 6, and can operate in cooperation with the paper feed device 2, the image reading device 4, and the winding device 5.

As the control unit 17, a microcomputer mainly composed of a CPU, ROM, RAM, and an I/O interface can be used. The CPU is based on an OS, and executes various programs etc. on the OS. The ROM stores a program for starting the image forming device 3. The CPU starts the image forming device 3 according to the program. Thereafter, the CPU loads programs stored in a hard disk device (not shown) or the like into the RAM, and executes various kinds of processing according to the loaded programs, thereby implementing various functions of the image forming device 3 (processor).

For the continuous paper P discharged from the image forming device 3, the image reading device 4 reads an image formed on the continuous paper P. The image reading device 4 is mainly composed of a reading conveying unit 40, an image reading part 45, and a control unit 46.

The reading conveying unit 40 includes a plurality of conveying rollers. The reading conveying unit 40 conveys the continuous paper P discharged from the image forming device 3 with the plurality of conveying rollers disposed along a conveyance path, and then discharges the continuous paper P to the winding device 5.

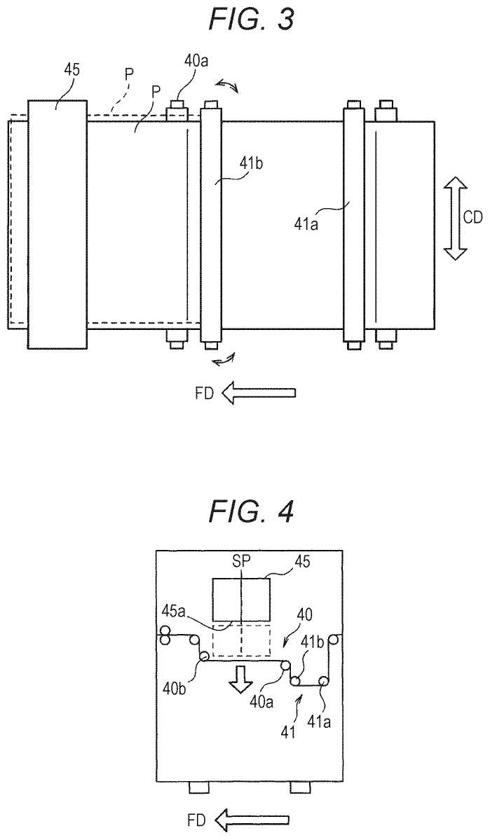

The reading conveying unit 40 includes a steering mechanism 41. The steering mechanism 41 is a mechanism that adjusts the position of the continuous paper P and the inclination of the continuous paper P in a paper width direction CD orthogonal to the paper conveyance direction FD. Here, FIG. 3 is an explanatory diagram explaining the steering mechanism 41 mounted in the image reading device 4.

In the present embodiment, the steering mechanism 41 includes a pair of steering rollers 41a and 41b between which the continuous paper P is stretched in a tensioned state. By tilting the steering roller 41b, the position or inclination of a paper area downstream from the steering roller 41b can be changed. The steering mechanism 41 is provided to correct the continuous paper P to a proper conveyance position or inclination. In the present embodiment, the steering mechanism 41 is used to intentionally change the position of the continuous paper P.

The image reading part 45 optically reads an image formed on the continuous paper P and generates a read image. The image reading part 45 is disposed opposite the continuous paper P conveyed along the conveyance path. The image reading part 45 has a reading region for reading an image which is elongated horizontally along the paper width direction CD. The reading region is set to a size larger than the size of the continuous paper P in the paper width direction CD.

Specifically, the image reading part 45 includes, for example, a light source that irradiates the continuous paper P with light, a line image sensor that receives the reflected light and reads the continuous paper P along the paper width direction CD, an optical system including a lens, a mirror, etc. which guides light reflected from printed matter to the line image sensor to form an image, and an AD conversion unit that converts an analog image signal output from the line image sensor into digital image data.

In the image reading device 4 of this configuration, the steering mechanism 41 is disposed upstream from a reading position SP of the image reading part 45. The steering mechanism 41 described above is designed to change the position or the like of the paper area downstream of the steering mechanism 41. Thus, the position of the continuous paper P passing under the image reading device 4 (reading position SP) can be moved in the paper width direction CD.

In the present embodiment, of the conveying rollers constituting the reading conveying unit 40, a conveying roller 40a located upstream of the image reading part 45 and a conveying roller 40b located downstream of the image reading part 45 can be moved from the home positions to retracted positions. FIG. 4 is an explanatory diagram showing the retracted positions of the conveying rollers 40a and 40b. The home positions mean positions to make the continuous paper P extending between the conveying rollers 40a and 40b face the image reading part 45 at a predetermined distance, and allow the image reading part 45 to read an image. On the other hand, the retracted positions mean positions where the conveying rollers 40a and 40b are retracted below the home positions, and can form a large space between the image reading part 45 and the continuous paper P. The conveyance distance of the continuous paper P in the image reading device 4 does not change between when the conveying rollers 40a and 40b are in the home positions and when the conveying rollers 40a and 40b are in the retracted positions. This allows switching between the home positions and the retracted positions without paper feed of the continuous paper P.

The control unit 46 has a function of controlling the image reading device 4. The control unit 46 is communicably connected to the paper feed device 2, the image forming device 3, the winding device 5, and the system controller 6, and can operate in cooperation with the paper feed device 2, the image forming device 3, and the winding device 5.

As the control unit 46, a microcomputer mainly composed of a CPU, ROM, RAM, and an I/O interface can be used. The CPU is based on an OS, and executes various programs etc. on the OS. The ROM stores a program for starting the image reading device 4. The CPU starts the image reading device 4 according to this program. After that, the CPU loads programs stored in a hard disk device (not shown) or the like into the RAM, and executes various kinds of processing according to the loaded programs, thereby implementing various functions of the image reading device 4 (processor).

When the control unit 46 determines that the continuous paper P has shifted from a specified conveyance position in the paper width direction CD, it performs a steering operation to control the steering mechanism 41 to return the continuous paper P to the specified conveyance position. Further, the control unit 46 performs image inspection based on a read image (image inspection operation). The image inspection is performed for calculating a correction value necessary for adjusting the image characteristics of the image forming device 3 and for evaluating image quality such as stains and reproducibility.

The winding device 5 winds up the continuous paper P discharged from the upstream device in accordance with an instruction from the system controller 6. The winding device 5 is provided with a tension application unit that urges the continuous paper P so that a constant tension is applied to the continuous paper P.

The system controller 6 has a function of centrally controlling the devices constituting the image forming system 1. The system controller 6 performs necessary control on these devices so that the paper feed device 2, the image forming device 3, the image reading device 4, and the winding device 5 operate in cooperation.

As a feature of the present embodiment, the control unit 46 of the image reading device 4 detects an abnormality in the image reading part 45. An abnormality in the image reading part 45 is an abnormality caused by the image reading part 45, and means a reading abnormality that appears in a specific position in the paper width direction CD, regardless of the conveyance position of the continuous paper P. An example thereof is adhesion of dirt such as paper powder to a reading surface 45a facing the continuous paper P. In this case, a streak (vertical streak) along the paper conveyance direction FD appears in a position where dirt has adhered. Hereinafter, abnormality detection performed by the control unit 46 will be described as dirt detection.

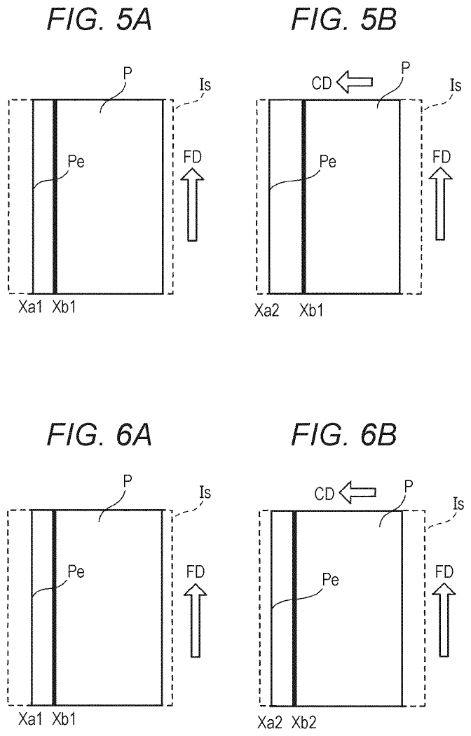

Hereinafter, an outline of a dirt detection operation will be described. Here, FIG. 5A and FIG. 5B and FIG. 6A and FIG. 6B are explanatory diagrams showing the concept of dirt detection. When a vertical streak is recognized on a read image, it can be considered that dirt has adhered to the reading surface 45a of the image reading part 45. However, if an image formed by the image forming device 3 is a mark linearly continuous along the paper conveyance direction FD, this image also appears in a vertical streak on the read image. Therefore, in order to perform dirt detection, it is necessary to distinguish between a vertical streak caused by dirt and a vertical streak as an image.

With reference to FIG. 5A and FIG. 5B, a vertical streak caused by dirt will be described. It is assumed that when an edge (a left edge in the figure) Pe of the continuous paper P is in a horizontal axis coordinate Xa1 in a read image Is, a vertical streak has appeared in a horizontal axis coordinate Xb1 (FIG. 5A). When the vertical streak is caused by dirt, the appearance position of the vertical streak is a specific position in the paper width direction CD. Therefore, even if the continuous paper P moves in the paper width direction CD, and the edge Pe of the continuous paper P moves to a horizontal axis coordinate Xa2 in the read image Is, the vertical streak remains in the horizontal axis coordinate Xb1 (FIG. 5B).

Next, a vertical streak as an image will be described with reference to FIG. 6A and FIG. 6B. It is assumed that when the edge Pe of the continuous paper P is in the horizontal axis coordinate Xa1 in the read image Is, a vertical streak has appeared in the horizontal axis coordinate Xb1 (FIG. 6A). When the vertical streak is an image formed on the continuous paper P, the appearance position of the vertical streak is a specific position on the continuous paper P. Therefore, if the continuous paper P moves in the paper width direction CD, and the edge Pe of the continuous paper P moves to the horizontal axis coordinate Xa2 in the read image Is, the vertical streak appears in a horizontal axis coordinate Xb2 (Xb2=Xb1−(Xa1−Xa2) (FIG. 6B).

Thus, in the present embodiment, the control unit 46 performs dirt detection by comparing the positions of a vertical streak, based on a first read image and a second read image that is different from the first read image in paper position at the time of image reading in the paper width direction CD.

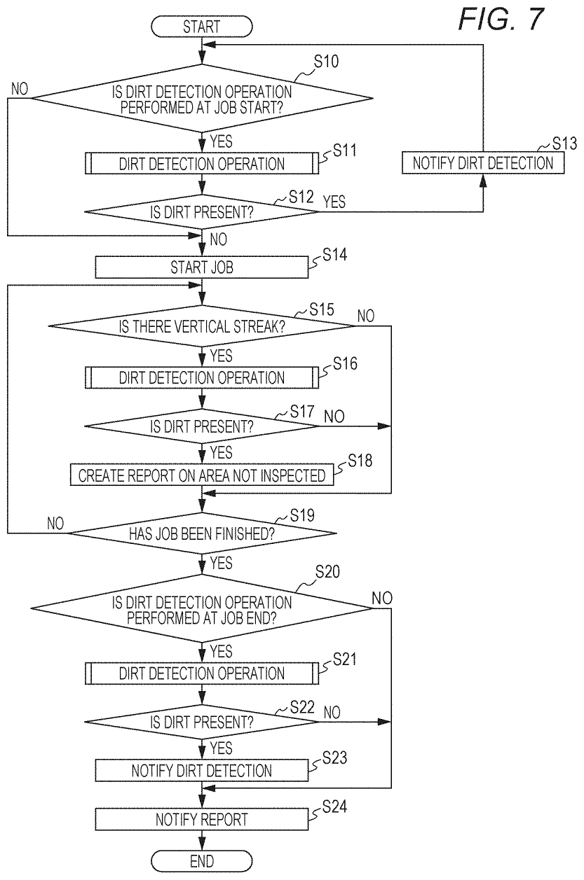

FIG. 7 is a flowchart showing an operation of the image reading device 4. Hereinafter, the operation of the image reading device 4 will be described. A process shown in the flowchart is executed by the control unit 46 of the image reading device 4 with execution of a job as a trigger.

First, in step S10, the control unit 46 determines whether to perform the dirt detection operation at the start of the job. Whether to perform the dirt detection operation at the start of a job is registered in advance as setting information for operating the image forming system 1, for example. The setting information is set at the time of shipment from the factory, or is set by user operation through the operation display unit 16. When the dirt detection operation is performed at the start of the job, an affirmative determination is made in step S10, and the process proceeds to step S11. On the other hand, when the dirt detection operation is not performed at the start of the job, a negative determination is made in step S10, and the process proceeds to step S14.

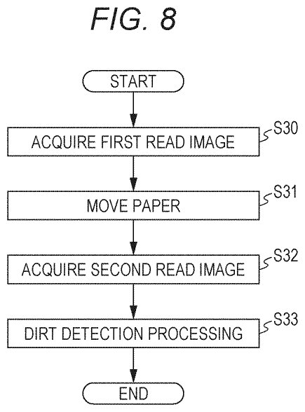

In step S11, the control unit 46 performs the dirt detection operation. FIG. 8 is a flowchart showing details of the dirt detection operation. In the dirt detection operation, it is necessary to convey the continuous paper P. In situations other than where a job is being executed, it is necessary to convey the continuous paper P in accordance with the dirt detection operation. Of course, when the continuous paper P is conveyed in another operation, for example, a warm-up operation before the start of a job, the dirt detection operation may be performed using this conveyance operation.

In step S30, the control unit 46 acquires a read image having a predetermined read size in the paper conveyance direction FD as the first read image.

In step S31, the control unit 46 controls the steering mechanism 41 to change the position of the continuous paper P in the paper width direction CD from the position when the first read image has been read.

In step S32, the control unit 46 acquires a read image having the predetermined read size in the paper conveyance direction FD as the second read image.

In step S33, the control unit 46 performs dirt detection processing. Specifically, the control unit 46 compares the first read image and the second read image to determine whether there is a vertical streak appearing in the same position on the read images. If a vertical streak appears in the same position, the control unit 46 determines that dirt is present. On the other hand, when there is no vertical streak or when the position of a vertical streak is different between the two read images, the control unit 46 determines that no dirt is present. A method of comparing positions of a vertical streak may be a method of calculating a difference image between the first read image and the second read image.

In step S12, the control unit 46 determines whether the result of the dirt detection processing is the presence of dirt. If dirt is present, an affirmative determination is made in step S12, and the process proceeds to step S13. On the other hand, if no dirt is present, a negative determination is made in step S12, and the process proceeds to step S14.

In step S13, the control unit 46 controls the operation display unit 16 of the image forming device 3 to notify information of the presence of dirt.

In step S14, the control unit 46 starts the job. When the job is started, the continuous paper P is conveyed along the paper conveyance direction FD, and an image is formed on the continuous paper P by the image forming device 3.

When the job is started, the control unit 46 acquires a read image in a predetermined cycle, and performs the image inspection operation. The image inspection operation is executed in parallel with the process shown in the flowchart.

In step S15, the control unit 46 refers to a read image acquired by the image inspection operation, and determines whether a vertical streak has appeared on the read image. Whether a vertical streak has appeared in the read image can be determined using a well-known image processing technique. If a vertical streak has appeared, an affirmative determination is made in step S15, and the process proceeds to step S16. On the other hand, if no vertical streak has appeared, a negative determination is made in step S15, and the process proceeds to step S19.

In step S16, the control unit 46 performs the dirt detection operation. Details of the dirt detection operation are as shown in steps S30 to S33.

In step S17, the control unit 46 determines whether the result of the dirt detection processing is the presence of dirt. If dirt is present, an affirmative determination is made in step S17, and the process proceeds to step S18. On the other hand, if no dirt is present, a negative determination is made in step S17, and the process proceeds to step S19.

In step S18, the control unit 46 creates a report on an area not inspected. As described above, the control unit 46 performs the image inspection operation. If a vertical streak due to dirt is reflected in an image inspection, the accuracy of the image inspection is affected. Therefore, when the control unit 46 has detected the presence of dirt, it excludes an area where the dirt has been detected, that is, the area of the vertical streak to perform the image inspection operation. The report on the area not inspected is for notifying the user of the area excluded in the image inspection operation, and is created by the control unit 46.

In step S19, the control unit 46 determines whether the job has been finished. When the job has been finished, an affirmative determination is made in step S19, and the process proceeds to step S20. On the other hand, if the job has not been finished, a negative determination is made in step S19, and the process returns to step S15.

In step S20, the control unit 46 determines whether to perform the dirt detection operation at the end of the job. Whether to perform the dirt detection operation at the end of a job is registered in advance as setting information for operating the image forming system 1, for example. When the dirt detection operation is performed at the end of the job, an affirmative determination is made in step S20, and the process proceeds to step S21. On the other hand, when the dirt detection operation is not performed at the end of the job, a negative determination is made in step S20, and the process proceeds to step S24.

In step S21, the control unit 46 performs the dirt detection operation. Details of the dirt detection operation are as shown in steps S30 to S33.

In step S22, the control unit 46 determines whether the result of the dirt detection processing is the presence of dirt. If dirt is present, an affirmative determination is made in step S22, and the process proceeds to step S23. On the other hand, if no dirt is present, a negative determination is made in step S22, and the process proceeds to step S24.

In step S23, the control unit 46 controls the operation display unit 16 of the image forming device 3 to notify information of the presence of dirt.

In step S24, when there is a report created in the previous processing, the control unit 46 controls the operation display unit 16 of the image forming device 3 to notify the contents of the report.

As described above, in the present embodiment, the image reading device 4 includes the image reading part 45 that is disposed opposite the continuous paper P conveyed along the conveyance path, and reads an image formed on the continuous paper P, and the control unit 46 that performs dirt detection on the image reading part 45 based on the first read image and the second read image each read by the image reading part 45. Here, the second read image is different from the first read image in paper position at the time of image reading in the paper width direction CD.

According to this configuration, by performing dirt detection using the first read image and the second read image, it is possible to properly distinguish a vertical streak caused by dirt from an image of a mark in a vertical streak. Further, in the present embodiment, since the position of the continuous paper P is shifted in the paper width direction CD, there is little influence on a read image. Consequently, image inspection can be performed accurately.

In the present embodiment, the image reading device 4 further includes the steering mechanism 41. In this case, the control unit 46 controls the steering mechanism 41 to change the position in the paper width direction CD, and performs the dirt detection operation with read images before and after the position has been changed as the first read image and the second read image.

According to this configuration, the steering mechanism 41 can change the position of the continuous paper Pin the paper width direction CD. Consequently, two kinds of read images different in position in the paper width direction CD can be effectively obtained.

In the present embodiment, the image reading device 4 includes the steering mechanism 41. However, there are no limitations on the position of the steering mechanism 41 as long as it can change the position of the continuous paper P passing the image reading part 45. However, since the steering mechanism 41 according to the present embodiment moves the paper area downstream from it, if the steering mechanism 41 is provided upstream from the image forming device 3, more specifically, the transfer nip, displacements will be produced on a transferred image. Therefore, the steering mechanism 41 according to the present embodiment is preferably provided downstream from the image forming position (the transfer nip) of the image forming device 3 and upstream from the reading position SP of the image reading part 45.

In the present embodiment, the steering mechanism 41 positively moves the continuous paper P, thereby changing the position of the continuous paper P in the paper width direction CD. However, the continuous paper P conveyed in the image forming system may change in position in the paper width direction CD (meander). Thus, the dirt detection operation may be performed by catching such meandering of the continuous paper P. Specifically, the control unit 46 may monitor an edge position of the continuous paper P, and use read images before and after the edge position of the continuous paper P has changed as the first read image and the second read image to perform the dirt detection operation.

In the present embodiment, the control unit 46 performs the dirt detection operation before the start of a job.

According to this configuration, dirt adhesion to the image reading part 45 can be detected prior to job execution. This can prevent job execution with dirt left adhering.

Further, in the present embodiment, the control unit 46 performs the dirt detection operation after the end of a job.

When the continuous paper P is conveyed by the execution of a job, dirt such as paper powder may swirl up and adhere to the image reading part 45. Thus, by performing the dirt detection operation after the end of a job, dirt that has adhered during the execution of the job can be detected.

In the above-described embodiment, during execution of a job, the dirt detection operation is performed when a vertical streak is determined. However, the control unit 46 may periodically repeatedly perform the dirt detection operation during execution of a job. Alternatively, the control unit 46 may perform the dirt detection operation when the steering operation is performed or when meandering is determined.

The control unit 46 may suspend a job when an abnormality in the image reading part 45 is detected. This can prevent the image inspection operation from being continued with dirt left adhering to the image reading part 45.

In the present embodiment, the conveying rollers 40a and 40b function as a switching mechanism that retracts the continuous paper P from the image reading part 45 to form a space between the image reading part 45 and the continuous paper P.

According to this configuration, a large space can be provided between the image reading part 45 and the continuous paper P. This facilitates removal of dirt adhering to the image reading part 45.

In the present embodiment, when the control unit 46 detects an abnormality in the image reading part 45, it excludes an area on the continuous paper P corresponding to an abnormal portion (a dirt adhering portion) of the image reading part 45 (a vertical streak appearing portion) to perform the image inspection operation.

According to this configuration, a vertical streak caused by dirt adhesion is excluded from inspection. This can prevent image inspection from being affected by the vertical streak. In addition, since a job is not suspended due to the result of image inspection caused by dirt, a reduction in downtime can be prevented to improve productivity.

In the present embodiment, the control unit 46 notifies the user of an area excluded in the image inspection operation.

According to this configuration, the user can be notified of which area has not been inspected.

In the present embodiment, when the control unit 46 detects dirt on the image reading part 45, it notifies the user of the dirt on the image reading part 45.

According to this configuration, the user can be notified of adhesion of dirt. This can prompt the user to remove dirt at an early stage.

In the above-described embodiment, dirt adhesion has been described as an abnormality in the image reading part 45. However, the present embodiment is not limited to this, and can include a wide range of reading abnormalities that appear in a specific position in the paper width direction CD. Such abnormalities other than adhesion of dirt include a scratch made on the reading surface 45a facing the continuous paper P, and an output abnormality in a sensor corresponding to a certain pixel. In particular, a case such as a scratch made on the reading surface 45a or a sensor output abnormality in a certain pixel is not remedied by cleaning the reading surface 45a. Even if the dirt detection operation is repeated a plurality of times, it is determined that dirt is present. Thus, if it is determined that dirt is present even after the dirt detection operation is repeated a plurality of times, it may be determined that a specific abnormality such as a scratch made on the reading surface 45a or a sensor output abnormality in a certain pixel has occurred. This information may be notified to the user.

The image reading device and the image forming system according to the embodiment of the present invention have been described above. It is needless to say that the present invention is not limited to the above-described embodiment, and various modifications can be made within the scope of the invention. A method of controlling the image forming system and the image reading device, and a program itself for causing a computer to execute the control method also serve as part of the present invention. An information recording medium storing the program also serves as part of the present invention.

Although paper is exemplified by continuous paper in the present embodiment, the present invention is applicable even to a single sheet of paper of a fixed size.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image reading device comprising:
an image reading part that is disposed opposite paper conveyed along a conveyance path, and reads an image formed on the paper; and
a hardware processor that performs an abnormality detection operation of detecting an abnormality in the image reading part, based on a first read image and a second read image that is different from the first read image in paper position at image reading time in a paper width direction orthogonal to a paper conveyance direction.

2. The image reading device according to claim 1, wherein the hardware processor monitors an edge position of the paper in the paper width direction, and performs the abnormality detection operation using read images before and after the edge position has changed as the first read image and the second read image.

3. The image reading device according to claim 1, wherein the paper is continuous paper.

4. The image reading device according to claim 3, further comprising:
a steering mechanism that adjusts the position of the paper in the paper width direction,
wherein the hardware processor controls the steering mechanism to change the position in the paper width direction, and performs the abnormality detection operation using read images before and after the position has been changed as the first read image and the second read image.

5. The image reading device according to claim 1, wherein the hardware processor performs the abnormality detection operation before a job is started.

6. The image reading device according to claim 1, wherein the hardware processor performs the abnormality detection operation after a job is finished.

7. The image reading device according to claim 1, wherein the hardware processor performs the abnormality detection operation while a job is being executed.

8. The image reading device according to claim 7, wherein the hardware processor periodically performs the abnormality detection operation while a job is being executed.

9. The image reading device according to claim 7, wherein the hardware processor suspends the job when the hardware processor has detected an abnormality in the image reading part.

10. The image reading device according to claim 1, wherein
the hardware processor performs a steering operation of controlling the steering mechanism to return the paper to a specified conveyance position when the hardware processor has determined that the paper has shifted from the specified conveyance position in the paper width direction, and
the hardware processor performs the abnormality detection operation when the hardware processor has executed the steering operation.

11. The image reading device according to claim 1, further comprising a switching mechanism that retracts the paper from the image reading part to form a space between the image reading part and the paper.

12. The image reading device according to claim 1, wherein
the hardware processor performs an image inspection operation of inspecting an image based on a read image read by the image reading part, and
the hardware processor performs the image inspection operation, excluding an area on the paper corresponding to an abnormal portion of the image reading part when the hardware processor has detected an abnormality in the image reading part.

13. The image reading device according to claim 12, wherein the hardware processor notifies a user of the area excluded in the image inspection operation.

14. The image reading device according to claim 1, wherein the hardware processor notifies a user of an abnormality in the image reading part when the hardware processor has detected the abnormality in the image reading part.

15. The image reading device according to claim 1, wherein
the image reading part has a reading region for reading an image which is elongated horizontally along the paper width direction, and
an abnormality in the image reading part is a reading abnormality that appears in a specific position in the paper width direction.

16. An image forming system comprising:
an image forming device that forms an image on paper; and
the image reading device according to claim 1 that is disposed downstream of the image forming device in the paper conveyance direction.

17. The image forming system according to claim 16, wherein
the paper is continuous paper,
the image reading device further comprises a steering mechanism that adjusts the position of the paper in the paper width direction, and
the steering mechanism is provided downstream from an image forming position of the image forming device and upstream from a reading position of the image reading part.

18. A method of controlling an image reading device that reads an image formed on paper conveyed along a conveyance path with an image reading part disposed opposite the paper, the method comprising:
reading an image formed on the paper and acquiring a first read image;
reading an image formed on the paper with a paper position at image reading time in a paper width direction orthogonal to a paper conveyance direction being different from a paper position of the first read image, and acquiring a second read image; and
detecting an abnormality in the image reading part, based on the first read image and the second read image.

19. A non-transitory recording medium storing a computer readable program causing a computer controlling an image reading device to perform the method of controlling the image reading device according to claim 18.
